(19) United States
(12) Patent Application Publication
(10) Pub. No.: US 2003/0004778 A1
(43) Pub. Date: Jan. 2, 2003

(54) Computer architecture and computer iplemented and/or assisted method of performing a cultural assessment of an organization and making improvements thereon

(76) Inventors: Brian R. Gareau, Peoria, IL (US); Jason P. Sage, Cary, NC (US)

Correspondence Address: CATERPILLAR INC., 100 N.E. ADAMS STREET, PATENT DEPT., PEORIA, IL, 616296490

(21) Appl. No.: 09/852,810

(22) Filed: May 10, 2001

(51) Int. Cl. G06F 17/60

(52) U.S. Cl. 705/10

(57) ABSTRACT

A method of assessing culture of an organization and making improvements thereon is described. The method includes the steps of collecting responses from members of the organization, compiling the responses into an analyzable data format, and determining themes or issues in the compiled data. The method may also include the steps of determining appropriate actions corresponding to the identified themes or issues, implementing the identified actions on the organization, and assessing an effect of the implementation on the organization. In addition, the method may also include the step of determining one or more corrective actions when the implementation has not be effective. Corresponding system, medium, expert system are also described.

### TECHNICAL FIELD

The present invention relates to a system, a medium and a method for assessing the culture of an organization and making improvements based on the assessment, and more particularly, to a computer architecture and computer implemented and/or assisted process of conducting a cultural assessment of an organization and generating recommendations and/or specific actions responsive thereto.

### BACKGROUND ART

It is known in the art to conduct employee satisfaction surveys. An exemplary conventional survey system is disclosed in U.S. Pat. No. 5,615,134 issued to Newsham et al. In that patent, as illustrated in FIG. 1, a user switches on a Personal Computer and is asked certain demographic questions that are only asked once. These demographic questions may comprise queries relating to age, sex, and education of the subject. Other questions relating to the physical location and orientation of the computer terminal may optionally be asked. The responses to these questions are then recorded on the system's hard disk. As can be seen from viewing the flow diagram, when a questionnaire is scheduled, a banner appears to ask the user if he or she wishes to respond to questions. If the answer is no, the questions may be rescheduled. Otherwise, the questions appear on a display terminal, and the selected responses are saved to the disk.

Another exemplary conventional system to conduct surveys is described in U.S. Pat. No. 6,026,387 issued to Kesel. FIG. 2 illustrates in block diagram form a schematic of the architecture of the conventional system disclosed in the patent issued to Kesel. That system includes a consumer feedback apparatus 10 for collecting, analyzing, and reporting consumer comments on goods and services offered for sale to consumers by a provider. The provider locates a comment receiving station 12 in a convenient location for consumers to selectively operate 14 a recorder for receiving oral comments from the consumer C.

After the comment is recorded by the consumer C, a date and time is associated with the comment 16. The recording station 12 includes a storage device for recording a plurality of comments from one or more consumers C. The recording station includes a digital telephone message recording device. Such devices typically include a date and time “stamp” for recorded messages. The provider may assign to consumers a unique identifier 11. The consumer C selectively enters the identification code upon recording the comment 16 and upon making purchases. In this way, the provider tracks the comments and purchasing activity of the consumer C. The collection of oral comments with the time stamp and consumer identification 11 are then communicated 18 to an analyzer for analysis and recording on a data base.

Each discrete oral comment by consumer C is analyzed 20, and a normalized representation is created. Normalized representations include comment factors 22 comprising a comment category 24, at least one descriptor 26, at least one dimension 28, and an attitude 30. The comment factors 22 are used to convert the raw oral comments into useable information about goods and services, i.e., for statistical analysis, whether the comment is a compliment, complaint, or idea for improvement. The normalized representation is preferably stored on a database driven by a microprocessor computer 32 which includes a display screen, microprocessor, a keyboard, and a mouse-type entry device. Using a reporter 34, normalized representations are selected according to the category, descriptor, dimension, attitude, and time. The normalized representations are used for reporting 36 information to the provider, for responding to perceptions of consumers about delivery and execution of services and goods and for monitoring levels of customer satisfaction according to a provider-defined index.

Many companies conduct employment satisfaction surveys. A recent gallop poll conducted among the employees of the fortune five hundred companies found that eighty percent of those companies conduct surveys. However, sixty percent of those responded to the poll reported a negative impact as result of the surveys. The cause of the negative impact can be manifold. The first reason may be that the conventional surveys can be either inaccurate and/or incomplete, thereby leading to incorrect survey results and incorrect remedial actions taken (or not taken) by the companies. The second reason may be that the conventional surveys may not provide follow up sessions and concrete implementation remedial actions.

In another aspect that may not relate to the above-described conventional employee survey system but may be relevant to the present invention, computer tools for assisting a person to make decisions are known in the art. An example of such a tool is described in U.S. Pat. No. 5,995,728 issued to Forman. This exemplary tool is illustrated in FIGS. 2A and 2B. This computer implemented tool is preferably stored on any computer readable tangible medium, such as a floppy diskette hard drive, computer memory, and the like, for execution by the computer hardware. As indicated in FIG. 2A, Step S1 of the process is for a decision maker (or decision makers) to define alternative solutions to a problem or opportunity (including description and abbreviation) on a computer screen. For example, in deciding whether to expand a company, alternatives might be to (A) Expand the company and build a new sub-division, or (B) Make no plans or further inquiries for expansion at this time, or (C) Wait 6 months, meanwhile collecting additional information.

Step S2 of the process is for the decision maker(s) to identify pros and cons for each alternative(s). The computer organizes this process by maintaining one screen for each alternative. A pro for one alternative might be a con for another alternative. For example, a pro for one alternative might be low cost, while a con for another alternative might be high cost.

In Step S3 of the process, the decision maker, guided by the computer, iteratively repeats Steps S1 and S2 until all alternatives have been identified and entered by the decision maker into the computer system. Step S4 of the process is for the computer to combine and list the pros and cons for all alternatives. Each pro or con will “point” to at least one objective. For example, a pro of reliable points to an objective of reliability. A con of expensive, points to an objective of low cost.

Step S5 of the process is for the decision maker to use the computer facilities provided for “converting” each pro and con to one or more objectives by manipulating each pro and con and identifying the objective(s) it points to. If an objective has not yet been identified (based on the pro or con to another alternative), the decision maker can use the computer facilities to drag and drop each pro and con to the “objectives” list according to Step S6. Note: it might be possible for a pro or con to point to more than one objective-for example, a car with a pro of “large” might point to the following objectives: comfort, carrying capacity, safety and fuel economy. One by one, each pro-con is converted to an objective.

Step S7 is a decision point for the decision maker to repeat steps S5 and S6 until all pros and cons have been converted into objectives. At Steps S8 and S9, the computer allows the decision maker to enter other objectives that come to mind (but do not correspond to any pros or cons) directly into an objectives list/hierarchy, or to construct a hierarchy by clustering related objectives.

In Step S10, the computer algorithm generates a display of the treeview of the resulting hierarchy of objectives. In Steps S11 and S12, the computer can convert the treeview into a “clusterview”. The computer maintained clusterview can be manipulated by the decision maker—rearranging, combining, separating and adding objectives as desired. Other pros/cons or objectives that come to mind are added by the decision maker in Steps S13 and S14. The treeviews and clusterviews are kept in synchronization by the computer and the decision maker can switch between either views in Step S15.

In Step S16, the computer appends the alternatives to the bottom level of the objectives hierarchy to produce an evaluation & choice model. The decision maker is then able to utilize this developed list of objectives in the decision making process, and makes a decision responsive thereto.

The above-described decision assisting tool does not assist a user in assessing the culture of an organization and making improvements based on the assessment.

Additional short comings of the conventional employee survey systems and the decision assisting tools will be clearly evident from the detailed description of the present inventions that follows.

### DISCLOSURE OF THE INVENTION

Embodiments of the present invention advantageously overcome the shortcomings of the conventional methods and system.

Accordingly, embodiments of the present invention includes a computer implemented or computer assisted method of measuring and assessing culture of an organization and making improvements thereon. The method includes the steps of collecting by at least one of computer and a user responses from members of the organization and compiling the responses into an analyzable data format generating compiled data. The method also includes the steps of determining at least one of themes and issues by analyzing the compiled data, determining at least one action corresponding to the at least one of themes and issues determined by said determining themes and issues step, and implementing the at least one action on the organization determined by said determining at least one action step. The method further includes the steps of assessing an effect of said implementing step on the organization, and determining at least one additional action responsive to the effect determined by said assessing step.

In another feature and advantage of the present invention, embodiments of the present invention includes performing at least one individual interview session with at least one of the members, performing at least one focus group meeting with at least one of the members, and performing at least one walk around visual assessment with at least one of the members.

Embodiments of the present invention may also include the step of separating the collected responses into groups. The present invention may further include the steps of determining ineffectual communication between employees and managers of the organization as a theme. The present invention may also include the step of increasing communication between employees and managers by posting relevant messages on a board or a Web page of the organization.

Embodiments of the present invention may also include a computer implemented or assisted method of analyzing data collected as part of a cultural assessment process. The data includes responses to qualitative questions and quantitative questions collected in at least one of a user interview computer program, individual interviews, focus group meetings, questionnaires, and culture assessment tools. Embodiments of the present invention may include the steps of calculating averages of the responses to the quantitative questions collected from the at least one individual interview and calculating averages of the responses to the quantitative questions collected from the at least one focus group meeting. Embodiments of the present invention may include the step of determining at least one of themes and issues by comparing the calculated averages of the responses to the quantitative questions collected from the at least one individual interview and the calculated averages of the responses to the quantitative questions collected from the at least one focus group meeting.

Embodiments of the present invention may include the steps of separating the collected data into a number of sets and determining at least one of themes and issues appearing repeatedly in the collected data for each set of data. The present invention may include the step of determining at least one of themes and issues by comparing the calculated averages and the responses to the qualitative questions.

Embodiments of the present invention also includes a computer implemented or assisted system for measuring and assessing culture of an organization and making improvements thereon. The system of the present invention includes means for collecting by at least one of computer and a user responses from members of the organization, means for compiling the responses into an analyzable data format generating compiled data, and means for determining at least one of themes and issues by analyzing the compiled data. Embodiments of the present invention also includes means for determining at least one action corresponding to the at least one of themes and issues determined by said means for determining themes and issues, means for causing the at least one action determined by said means for determining at least one action to be implemented on the organization, and means for assessing an effect made by said implementation of at least one action on the organization.

In some embodiments of the present invention, the system may further include means for compiling data collected from at least one individual interview session with at least one of the members, means for compiling data collected from at least one focus group meeting with at least one of the members, and means for compiling data collected from at least one walk around interview with at least one of the members.

The system of the present invention may also include means for separating the collected responses into groups. The system of the present invention may include means for determining ineffectual communication between employees and managers of the organization as a theme.

Embodiments of the present invention may include a computer implemented or assisted system for analyzing data collected as part of a cultural assessment process. The data includes responses to qualitative questions and quantitative questions collected in at least one of a user interview computer program, individual interviews, focus group meetings, questionnaires, and culture assessment tools. The system may include means for calculating averages of the responses to the quantitative questions collected from the at least one individual interview, means for calculating averages of the responses to the quantitative questions collected from the at least one focus group meeting, and means for determining at least one of themes and issues by comparing the calculated averages of the responses to the quantitative questions collected from the at least one individual interview and the calculated averages of the responses to the quantitative questions collected from the at least one focus group meeting.

The system of the present invention may also include means for separating the collected data into a number of sets, and means for determining at least one of themes and issues appearing repeatedly in the collected data for each set of data. The system may further include means for determining at least one of themes and issues by comparing the calculated averages and the responses to the qualitative questions.

Embodiments of the present invention may include a computer readable medium including instructions being executed by a computer. The instructions instructing the computer to measure and/or assess culture of an organization and make improvements thereon. The medium may include instructions for to collecting by at least one of computer and a user responses from members of the organization, compiling the responses into an analyzable data format generating compiled data, and determining at least one of themes and issues by analyzing the compiled data. The medium may also include instructions for determining at least one action corresponding to the at least one of themes and issues determined by said instructions for determining themes and issues, causing the at least one action determined by said instructions for determining at least one action to be implemented on the organization, and assessing an effect made by said implementation of at least one action on the organization.

The medium may also include instructions for compiling data collected from at least one individual interview session with at least one of the members, compiling data collected from at least one focus group meeting with at least one of the members, and compiling data collected from at least one walk around interview with at least one of the members.

In some embodiments of the present invention, the medium may include instructions for separating the collected responses into groups. The medium may also include instructions for determining ineffectual communication between employees and managers of the organization as a theme.

Embodiments of the present invention may include a computer readable medium including instructions being executed by a computer. The instructions instructing the computer to analyze data collected as part of a cultural assessment process. The data includes responses to qualitative questions and quantitative questions collected in at least one of a user interview computer program, individual interviews, focus group meetings, questionnaires, and culture assessment tools. The medium may include instructions for calculating averages of the responses to the quantitative questions collected from the at least one individual interview, calculating averages of the responses to the quantitative questions collected from the at least one focus group meeting, and determining at least one of themes and issues by comparing the calculated averages of the responses to the quantitative questions collected from the at least one individual interview and the calculated averages of the responses to the quantitative questions collected from the at least one focus group meeting.

In some embodiments of the present invention, the medium may further include instructions for separating the collected data into a number of sets, and determining at least one of themes and issues appearing repeatedly in the collected data for each set of data. The medium may also include instructions for determining at least one of themes and issues by comparing the calculated averages and the responses to the qualitative questions.

Embodiments of the present invention may also include an expert system. The expert system includes a processor and a computer readable medium including instructions executable by said processor. The instructions instructing the computer to measure and/or assess culture of an organization and make improvements thereon. The medium may include instructions for collecting by at least one of computer and a user responses from members of the organization, compiling the responses into an analyzable data format generating compiled data, and determining at least one of themes and issues by analyzing the compiled data. The medium may also include instructions for determining at least one action corresponding to the at least one of themes and issues determined by said instructions for determining themes and issues, causing the at least one action determined by said instructions for determining at least one action to be implemented on the organization, and assessing an effect made by said implementation of at least one action on the organization.

The expert system may also include instructions for compiling data collected from at least one individual interview session with at least one of the members, compiling data collected from at least one focus group meeting with at least one of the members, and compiling data collected from at least one walk around interview with at least one of the members.

The expert system may also include instructions for separating the collected responses into groups. The expert system may also include instruction for determining ineffectual communication between employees and managers of the organization as a theme.

Embodiments of the present invention may include an expert system that comprises a processor and a computer readable medium including instructions executable by said processor. The instructions instructing the computer to analyze data collected as part of a cultural assessment process, wherein the data includes responses to qualitative questions and quantitative questions collected in at least one of a user interview computer program, individual interviews, focus group meetings, questionnaires, and culture assessment tools. The expert system may include instructions for calculating averages of the responses to the quantitative questions collected from the at least one individual interview, calculating averages of the responses to the quantitative questions collected from the at least one focus group meeting, and determining at least one of themes and issues by comparing the calculated averages of the responses to the quantitative questions collected from the at least one individual interview and the calculated averages of the responses to the quantitative questions collected from the at least one focus group meeting.

The expert system may also include instructions for separating the collected data into a number of sets and determining at least one of themes and issues appearing repeatedly in the collected data for each set of data. The expert system may also include instructions for determining at least one of themes and issues by comparing the calculated averages and the responses to the qualitative questions.

It is a feature and advantage of the present invention to provide, in a computer system to measure and/or assess culture of an organization and make improvements thereon, a computer data signal embodied in a carrier wave. The signal bearing instructions to be executed by the computer system. The signal may bear instructions for collecting by at least one of computer and a user responses from members of the organization, compiling the responses into an analyzable data format generating compiled data, and determining at least one of themes and issues by analyzing the compiled data. The signal may bear instructions for determining at least one action corresponding to the at least one of themes and issues determined by said instructions for determining themes and issues, causing the at least one action determined by said instructions for determining at least one action to be implemented on the organization, and assessing an effect made by said implementation of at least one action on the organization.

In embodiments of the present invention, the signal may bear instructions for compiling data collected from at least one individual interview session with at least one of the members, compiling data collected from at least one focus group meeting with at least one of the members, and compiling data collected from at least one walk around interview with at least one of the members.

The signal may also bear instructions for separating the collected responses into groups. The signal may also bear instructions for determining ineffectual communication between employees and managers of the organization as a theme.

It is a also a feature and advantage of the present invention to provide in a computer system to analyze data collected as part of a cultural assessment process. The data includes responses to qualitative questions and quantitative questions collected in at least one of a user interview computer program, individual interviews, focus group meetings, questionnaires, and culture assessment tools, a computer data signal embodied in a carrier wave. The signal bearing instructions to be executed by the computer system. The signal bearing the instructions for calculating averages of the responses to the quantitative questions collected from the at least one individual interview, calculating averages of the responses to the quantitative questions collected from the at least one focus group meeting, and determining at least one of themes and issues by comparing the calculated averages of the responses to the quantitative questions collected from the at least one individual interview and the calculated averages of the responses to the quantitative questions collected from the at least one focus group meeting.

The signal may also bear the instructions for separating the collected data into a number of sets and determining at least one of themes and issues appearing repeatedly in the collected data for each set of data. The signal can further bear the instructions for determining at least one of themes and issues by comparing the calculated averages and the responses to the qualitative questions.

There has thus been outlined, rather broadly, the features and advantages of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other features and advantages of the invention, along with the various features of novelty which characterize the invention, are pointed out with particularity in the claims annexed to and forming a part of this disclosure. For a better understanding of the invention, its operating advantages attained by its uses, reference should be had to the accompanying drawings and descriptive matter in which there is illustrated preferred embodiments of the invention.

Other features and advantages of the present invention will be evident to those of ordinary skill, particularly upon consideration of the following detailed description of the preferred embodiments.

### BRIEF DESCRIPTION OF THE DRAWINGS

The detailed description of embodiments of the present invention showing various distinctive features may be best understood when the detailed description is read in reference to the appended drawing in which:

FIG. 1 is a flow chart showing operation of a conventional system related to one embodiment of a conventional survey method;

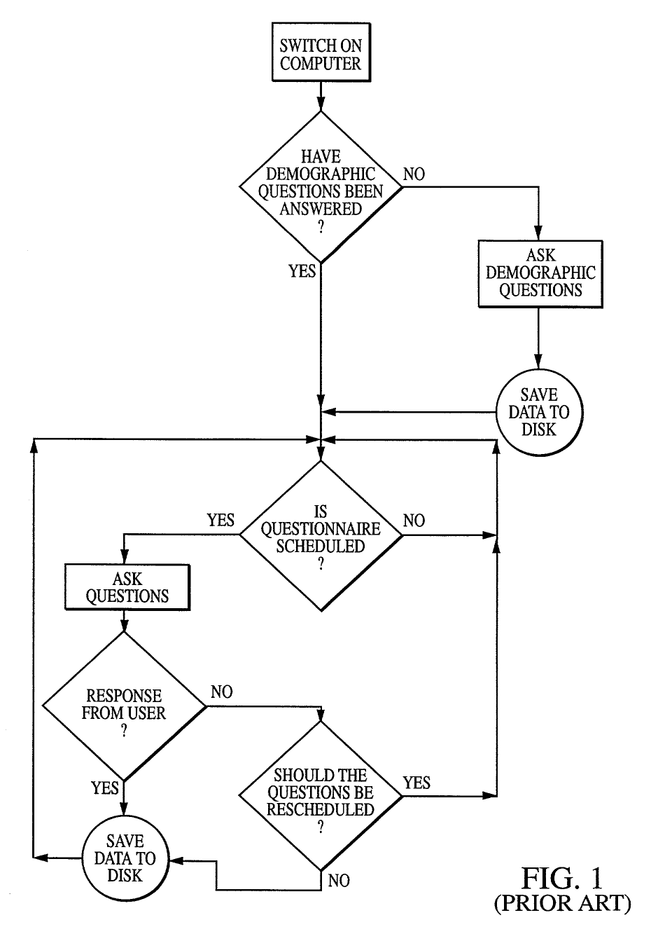

FIG. 2 is a schematic block diagram of the architecture of a consumer feedback apparatus of a conventional method for collecting, analyzing and reporting consumer comments on goods and services offered for sale to consumers;

FIG. 2A and 2B are flow charts illustrating a conventional decision assisting tool;

FIG. 3 is a flow chart illustrating an exemplary high level process in accordance with embodiments of the present invention;

FIG. 4 is a flow chart illustrating an exemplary data collection step in accordance with embodiments of the present invention;

FIG. 5 is a flow chart illustrating an exemplary data collection logistics step in accordance with embodiments of the present invention;

FIG. 6 is a flow chart illustrating an exemplary data compilation step in accordance with embodiments of the present invention;

FIG. 7 is a flow chart illustrating an exemplary data analysis step in accordance with embodiments of the present invention;

FIG. 8 is a flow chart illustrating an exemplary detailed data analysis step in accordance with embodiments of the present invention;

FIG. 9 is a flow chart illustrating an exemplary implementation step in accordance with embodiments of the present invention;

FIG. 10 is a graph illustrating an exemplary time line of various follow up meetings in accordance with embodiments of the present invention;

FIG. 11 is a table for entering low hanging fruits in accordance with embodiments of the present invention;

FIG. 12 is a table illustrating an exemplary implementation matrix in accordance with embodiments of the present invention;

FIG. 13 is a block diagram illustrating an example of a combined Internet, POTS, and ADSL architecture which may be used to implement embodiments of the present invention;

FIG. 14 is a block diagram illustrating one example of a central processing unit for implementing a computer process in accordance with a computer implemented embodiment of the present invention;

FIG. 15 is a block diagram of a computer system that includes a server according to embodiments of the present invention; and

FIG. 16 is a diagram illustrating a floppy disk that may store various portions of the software according to embodiments of the present invention.

### BEST MODE FOR CARRYING OUT THE INVENTION

Reference now will be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In order to provide the context in which the present invention is to be practiced, a description of the overall process in accordance with embodiments of the present invention is first provided. Subsequently, specific exemplary embodiments with various steps are described.

The first concept to be described in order to provide the proper context for embodiments of the present invention relates to organizations that would undergo the processes in accordance with embodiments of the present invention. Examples of organizations can be any company having a number of employees (e.g., 100 or more), a sub-unit (e.g., a department, a division or the like) within a company, a social club, etc. Basically, an organization for the purpose of the present invention is any group of people in which its culture can be assessed.

The second concept to be described in order to provide the proper context for embodiments of the present invention relates to various elements that constitute a culture or set of cultures of an organization.

A first element that contributes to the culture of the organization are assumptions held by its members (e.g., the employees of a company). In the context of the present invention the assumptions relate to subjective interpretations of the members that have been accepted as facts or givens even though the interpretations may be inaccurate.

A second element that may constitute or contribute to the culture of the organization are its norms, customs, routines perceived by the members of the organization. This element relates to day-to-day ways the members behave, interact and work together within the organization.

A third element that may constitute or contribute to the culture of the organization is power. This element of power is not just the title of the person holding the power, but the ability that the person can influence meaningful decisions within the organization.

A fourth element that may constitute or contributes to the culture of the organization is its positive/negative rights and rituals. These elements relate to ceremonies and events of the organization. The ceremonies and events may signal to or inform the members the value and emphasis of the organization.

A fifth element that may constitute or contribute to the culture of the organization in its roles and responsibilities of the members.

A sixth element that may constitute or contribute to the culture of the organization are its positive/negative stories and myths of the organization. This element helps describe the history of the organization.

A seventh element that may constitute or contribute to the culture of the organization is its structure. The structure relates to the framework that identifies relationships, communications, and power outside of the members of the organization (i.e., informal organizational chart).

An eighth element that may constitute or contribute to the culture of the organization relates to its symbols. The symbols in context of the present invention relate to non-verbal communications that may help explain values and beliefs of the organization.

A ninth element that may constitute or contribute to the culture of the organization are its systems and rules. This element relates to methods to control, measure, and reinforce behaviors of the members of the organization.

A tenth element that may constitute or contribute to the culture of an organization is its values. This element relates to what the organization cares about the most, regardless of the external environment.

The above-described elements of the culture of an organization are provided only as examples. These elements may not constitute an exhaustive list of the elements of culture of an organization, and do not necessarily apply to every organization. It should be noted, however, that in embodiments of the present invention the complex nature of culture of an organization is broken into manageable elements. These manageable elements are then used in developing the overall strategy in assessing the culture in accordance with embodiments of the present invention.

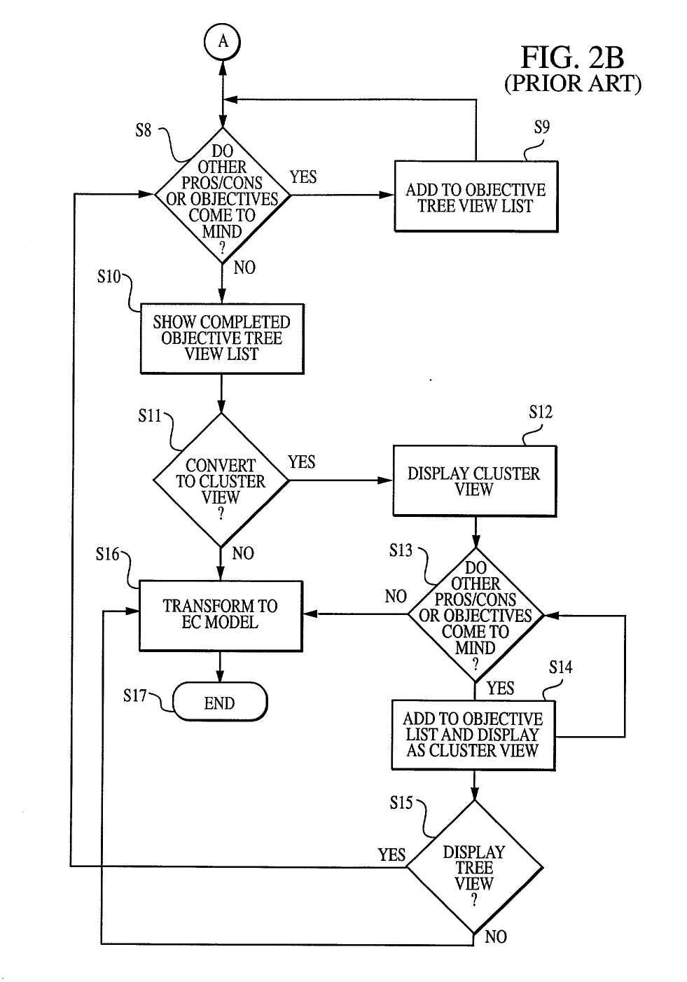

Based on or using one or more of the elements of the culture described above and/or other elements of culture, the computer architecture and computer implemented and/or assisted method of the present invention assesses the culture of an organization and makes improvements thereon. FIG. 3 illustrates a high-level flow chart diagram that includes the process steps of one embodiment of the present invention. As a first step, data is collected from the members of the organization. For instance, group meetings are held (e.g., a focus group meetings) and/or individual interviews are conducted to collect data (step 301), among others. The collected data is then analyzed to identify themes/issues in the data (step 303). Based on the identified themes/issues in the data, an implementation plan is created (step 305). The implementation plan is performed during an implementation phase. During and/or after the implementation phase, the progress of the implementation is assessed (step 307). When sufficient improvements on the culture of the organization have been determined or measured, the process of the present invention is optionally completed after the implementation phase (step 309). When there has not been sufficient improvement on the culture of the organization, the process may optionally be repeated from, for example, the data collecting step (step 301) and/or from the implementation step (step 305). The above-described high-level flow chart and its individual steps are described below in detail.

Before specific embodiments of the present invention are described, a number of actors who participate in embodiments of the present invention are introduced. The first actor is a facilitator(s) who carries out a number of steps in accordance with embodiments of the present invention. A facilitator can be a person. However, many steps described below as to be performed by a facilitator can be automated (e.g., computerized) to the extent that they are known in the computer automation art. Examples of the automated survey systems have been described above in connection with the conventional survey collection systems. The second actor is a client. A client can be a manager, an officer or the like who made the request to conduct the process of embodiments of the present invention, to develop improvements thereon in accordance with embodiments of the present invention. The third actors are a number of members (e.g., employees) who belong to the organization. The members may include the client and employees who may or may not be participating in the processes of various embodiments of the present invention. In the following description, the organization is depicted as a company having employees and a management team. It should be noted, however, any type of organization as described above can undergo the processes in accordance with the embodiments of the present invention.

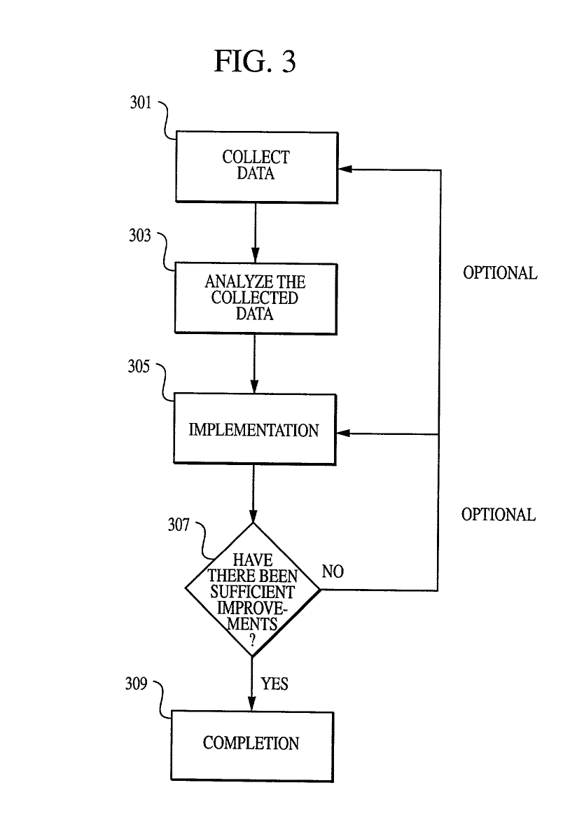

Now referring back to the data collecting step (step 301), FIG. 4 illustrates the detailed steps that may be carried out as part of step 301. The first step in collecting data consults the client (step 401) and devises data collection logistics (step 403). Subsequently, a set of generic questions is customized in order to assess accurately the culture of the organization (step 405). It should be noted that these steps can be performed in parallel or sequentially.

During the client consulting step (step 401), the facilitator provides an overview of the steps that are to be performed by the facilitator with respect to events and/or milestones that may take place in conducting the processes of embodiments of the present invention. In this step, the facilitator can first explain to the client, for example, the time and expense that may be required to be expended by the organization in order to conduct the processes of embodiments of the present invention. This would help the client to perform cost/benefit analysis before being fully committed to undergo the processes of embodiments of the present invention. Secondly, during this step the facilitator may, for example, outline time and resources needed by the client for a successful execution of the processes of embodiments of the present invention.

The client consulting step (step 401) may be conducted in person by the facilitator. In another embodiment, the consulting step may be conducted by asking the client to read published material (e.g., printed brochures and/or a Web Site that the client can log on and receive Web Pages containing information relating to this step).

During the client consultation step, the facilitator may also ask one or more of the following exemplary questions to the client (the “consultation questions”):

1. Is this the right time to make a commitment to conduct the processes of embodiments of the present invention, i.e., to measure the culture of your organization?

2. What is the number of employees that can participate in the process of embodiments of the present invention? It should be noted that in embodiments of the present invention 90-95% statistical confidence factor (SCF) is desired. Other standard statistical confidence factors or statistical distributions may optionally be used that indicate a sufficient probability of successful measurement and/or improvement of the culture.

3. Is it possible to breakdown the members into a number of organizational groups? Examples of possible organizational groups may be defined by functional departments (e.g., accounting dept., engineering dept., legal dept., secretarial support, etc.), by shifts (e.g., the morning shift, the afternoon shift and the evening shift), by pay grades, etc. The organizational group breakdown may depend upon the size of each organizational group and/or the clients desire to assess the culture of certain organizational groups.

4. What is the ideal timeline for the client? This would depend upon factors such as the urgency with which the client desires to assess the culture, availability of the members of the organization to participate in the processes of the present invention and other similar factors.

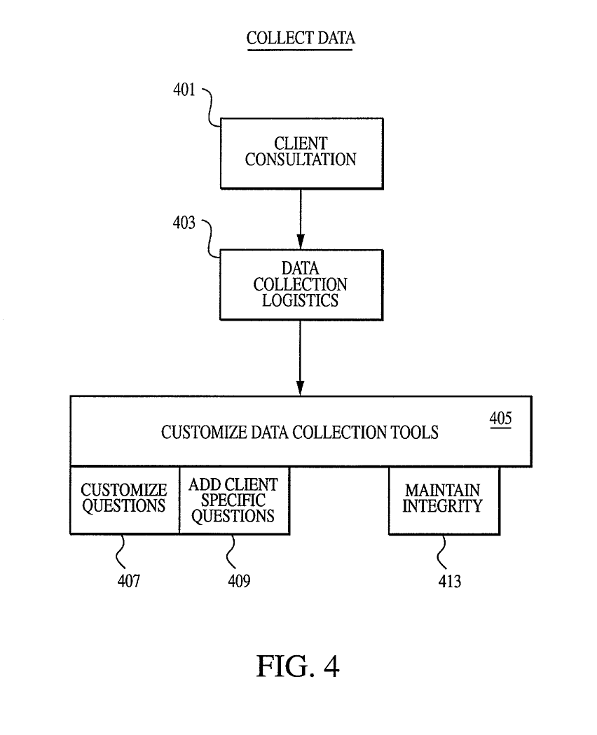

Now turning to FIG. 5, in which the logistics step (step 403) is described in more detail in accordance with one exemplary embodiment, the first step in the data collection logistics step is to determine the number of focus groups (step 501). The second step is to determine the number of individual interviews to conduct (step 503). The third step is to determine the number of facilitators needed to conduct the cultural measurement and improvement processes of the present invention (step 505). The fourth step is to determine if the above determined numbers meet a minimum objective (e.g., more than 90-95% statistical confidence factor). If it is not met, then the three determining steps (steps 501, 503 and 505) are optionally repeated. If it is met, then the facilitator uses numbers determined in the previous steps as the basis or input to additional steps in the present invention, either alone, in conjunction with other data. The detailed nature of the focus groups and individual groups and individual groups are described later.

In the step of determining the number of focus groups to be held (step 501), the facilitator may determine the number of focus groups required for each organizational group. It should be noted that the size of a focus group is preferred to be 12 with a minimum number (e.g., six). Focus group meetings are conducted preferably with two facilitators.

In the step of determining the number of individual interviews to be held (step 503), if an organizational group is rather large (e.g., the supervisory staff is large with more than 20 members), then the focus groups and individual interviews can be combined into one session. It should be noted that each focus group and individual interview may require approximately 90 minutes.

The facilitator may also receive the hours of operation the client would like to conduct the processes of the embodiments of the present invention. Based upon the information collected and determinations made above, the facilitator may provide a master schedule.

An exemplary “Master Schedule” may include the following entries:

“During our staff meeting, we reviewed all schedules and would propose the following master template for your cultural assessment process.”

| | |
|---|---|
| “U.S. Locations | October 4, 5, 9, |
| Proposed Dates: | 12, 13. |
| Format: | 7:30-9:00 a.m. (2) |
| | Focus Groups; |
| | 9:15-10:45 a.m. (2) Focus |
| | Groups; |
| | 11:30 a.m.-1:00 p.m. (2) |
| | Focus Groups |
| | 1:15-2:45 p.m. (1) Focus |
| | Group and (2) Interviews |
| | 3:00-4:30 p.m. (4) |
| | Interviews.” |

“Note: The above schedule has two teams of two facilitators each.”

| | |
|---|---|
| “European Locations | October 16, 17, 18 |
| Proposed Dates: | |
| Format: | 8:00-9:30 a.m. (1) |
| | Focus Group; |
| | 9:45-11:15 a.m. (1) Focus |
| | Group; |
| | 11:30 a.m.-1:00 p.m. (1) |
| | Focus Group; |
| | 2:00-3:30 p.m. (2) |
| | Interviews; |
| | 3:45-5:15 p.m. (2) |
| | Interviews |

Note: The above schedule has one team of two facilitators.”

“Please advise if this template and proposed dates will work for your organization.”

Now referring back to FIG. 4, in step 405, a set of generic data gathering tools are customized based on the needs of the organization. The generic data gathering tools include one or more of the following: an individual interview guideline, employee feedback sheet, and focus group meeting guideline, among others. Customizations include, for example, length of interviews, number of facilitators, pre-written multiple choice feedback questions, and/or other customizations that reflect or are desirable for a specific organization.

### GENERIC INDIVIDUAL INTERVIEW GUIDELINE

The following is an exemplary generic guideline to be followed by the facilitator when conducting individual interviews with the participating members of the organization. In embodiments of the present invention, the guidelines are divided into five exemplary sections.

### First Section of the Generic Individual Interview Guideline

The first section includes questions directed to collecting demographic information. Exemplary questions can be as follows: “What is the today's date?”; “What is your name?”; “What is the length of time you have been with the organization?“; ”What is your area of responsibility in the organization?”; “What is the number of people reporting to you?”; and “What is the length of time you have been at your current position?”

### Second Section of the Generic Individual Interview Guideline

The facilitator may first ask the following four (4) questions from a “big picture, 20,000 foot level.” The facilitator may ask that the responses may focus on customer, shareholder, and/or employee satisfaction/expectations.

The four questions are: 1) “What's going right?”; 2) “What's misunderstood and/or needs more clarification?”; 3) “What's frustrating?“; and 4) “What needs to be changed and/or improved?”

### Third Section of the Generic Individual Interview Guideline

The facilitator may ask the following questions and ask the interviewee to briefly answer the questions:

“What are some things in (YOUR ORGANIZATION/FACILITY) that are not written down and/or based on data but are collectively accepted as fact?”

“How would you best describe the typical way people behave, interact, and work in (YOUR ORGANIZATION/FACILITY)?”

“Some people just naturally attract other people . . . they influence others opinions. Who comes to mind here? Why? (Note: influencers are not always an expert in the area of discussion. Titles and positions are not necessarily needed. Influencers can be either negative or positive.)”

“What are some significant events for (YOUR ORGANIZATION/FACILITY) in the last 12 months?”

“What type of celebrations does (YOUR ORGANIZATION/FACILITY) have?”

“How do people know what is expected of them and what tasks they are responsible for completing?”

“How does (YOUR ORGANIZATION/FACILITY) motivate, monitor and reinforce desired behavior?”

“What does (YOUR ORGANIZATION/FACILITY) care about the most, regardless of the external environment?”

### Fourth Section of the Generic Individual Interview Guideline

The facilitator may ask the interviewee to rate the following questions on a scale of 1-10 (1=Very Poor/Strongly Disagree and 10=World Class/Strongly Agree), then ask the member to explain the rating:

“I know what is expected of me.”

“I have the materials, equipment, and training I need to do my job.”

“Our internal communications and feedback system in (YOUR ORGANIZATION/FACILITY) is?”

“(YOUR ORGANIZATION/FACILITY) is committed to consistently doing quality work and we do?”

“We have an adequate recognition process in place (formal and informal)?”

“Conflict/disagreement is easily resolved in (YOUR ORGANIZATION/FACILITY) at all levels?”

“Management is consistent in their expectations for employee performance and behaviors? (Does not vary by department/shift/area)”

“Our management team is doing an adequate job of listening, and building one on one relationships? How much time do you personally spend with employees in their work areas?”

“Our people trust the management of our organization/facility . . . believe what management says . . . believe management care about them?”

“Our ratio of supervisors to employees is adequate (not too many and not too few)?”

### Fifth Section of the Generic Individual Interview Guideline

The facilitator may wrap up the interview session by asking the interviewee to briefly describe the following:

“The basic assumptions we have about people in (YOUR ORGANIZATION/FACILITY) are?”

“In the last twelve (12) months, I believe our organization/facility is a better/same/worse place to work. Choose one. Explain why?”

“The #1 thing (realistic and specific) we should do that would improve morale and employee satisfaction in the next 90-120 days is?”

In the above described Generic Interview Guideline, only qualitative responses are solicited in the first, second, third and fifth sections. However, in the fourth section, quantitative (e.g., the rating) responses are also solicited. Of course, other types of questions may be asked and/or other arrangements or combination of the questions may be sued for this overall process step. Further, the above process steps may be implemented with the assistance of the computer system described below, and/or the data derived there from are entered into the computer system for processing, as described further below.

### GENERIC EMPLOYEE FEEDBACK SHEET

The following is an exemplary generic employee feedback sheet that asks the members to review the statements below. After each statement, the members are asked to put a rating of 1-10 (e.g., quantitative responses). A rating of “1” is poor; and “10” is excellent. Other standard points systems may also be utilized, in this step as well as other steps in the process of the present invention, as described herein. Additional comments may be written by the interviewee (e.g., qualitative responses). The following two exemplary groups are to be rated for each of the questions: direct supervisor of the member responding to the questions and the entire management team of the organization.

### Employee Involvement Section of the Generic Employee Feedback Sheet

1. “Encouraging your cooperation with fellow employees and the supervisory staff.

2. “Soliciting your ideas and involving you in discussions about work related issues.”

3. “Helping you gain a better understanding of your responsibilities each day.”

4. “Creating an environment where you feel Involved in things.”

### Communications Section of the Generic Employee Feedback Sheet

5. “Providing timely feedback on how you are doing.”

6. “Providing you with information that affects your ability to get the job done right and on time.”

7. “Providing consistent, clear communications.”

8. “Sharing general business information with you.”

9. “Listening to your questions and/or concerns and providing meaningful feedback.”

10. “Resolving mixed messages quickly.”

### Personal Rapport Section of the Generic Employee Feedback Sheet

11. “Getting to know you as an individual.”

### Leadership Section of the Generic Employee Feedback Sheet

12. “Showing full appreciation for work done.”

13. “Providing fair and consistent direction.”

14. “Demonstrating flexibility.”

15. “Allowing you the freedom to make some decisions.”

16. “Allowing you to complete assignments with support, but not interference.”

17. “Explaining why we made a decision or work procedure that way.”

### Overall Supervision Effectiveness Section of the Generic Employee Feedback Sheet

18. “Supervising you in general.”

19. “Creating an open, honest, environment of trust.”

20. “Being approachable.”

21. “Emphasizing quality in everything we do.”

22. “Creating and building an effective team.”

23. “Walking Their Talk? Do they do what they say they are going to do.”

This concludes the employee feedback sheet. Any number and/or combination of the above statements may be used, as well as other statements than an employee may comment on regarding the organization. The next section describes focus group meeting guidelines.

### FOCUS GROUP MEETING GUIDELINES

First, the facilitator may introduce and welcome the members participating in the focus group meeting. In particular, the facilitator may explain the purpose of the focus group meeting. For instance, the facilitator may state that the members in the focus group have been carefully selected by the management team. The facilitator may also state that the focus group meeting does not necessarily replace the “All Employee Survey to be held later.”

Following the introduction, the facilitator may also explain that there are three guarantees to the members who are participating in the focus group meeting. First, the participant focus group meeting is anonymous relative to the information provided by the participants. Second, the thought and concerns expressed in the focus meeting will be reported directly to the management. Third, the facilitator has encouraged the management team to be committed to the process and provide feedback as part of a 100-day action plan or other action plan. The facilitator may also promise to provide feedback to management on a specific date. One or more of those guarantees can also be omitted by the facilitator based on certain circumstances (e.g., the employee/management relationship).

Continuing to describe the focus group meeting, the facilitator may also state to the focus group that the facilitator is to determine the relationship between the members and their management team who are not present in the focus meeting. In particular, the facilitator may be concerned with determining the areas in which the members and their management team are connected (e.g., communicating with each other, and goals and rewards are clearly defined and well understood), and the areas in which the members and their management team are not connected.

The facilitator may also conduct one or more of the following exemplary exercises:

1. Words and Their Meanings Exercise: In this exercise the facilitator may ask the following questions: “If we did something one-half of the time, what percentage would that equate to?”; and “We also have some words/phrases/acronyms that we use at work that are well understood, and others that are not well understood.” The facilitator may ask the members in the focus groups to list those words.

2. Trust Exercise—In this exercise, the facilitator asks the members to break into small groups and asks them to list the characteristics of someone that they trust very much, outside of the workplace. The facilitator then may ask to write the list of the characteristics that each small group has defined. The facilitator may then ask the participants to indicate which two or three characteristics of the management team of the organization, and which of the characteristics that the management team needs to improve.

3. Ask to list what is going right at the organization.

4. Ask to list what is frustrating at the organization.

5. Walk the Talk exercise described below.

6. “One thing, which must be realistic, that you would change to make the organization a better place to work in the next 90-120 days.”

7. Pass out the employ feedback sheet and ask everyone to be honest and to not mark with identical responses to every question also includes blank spaces for comments and feedbacks.

The above-described generic guidelines are provided herein as examples. Similar or other known standard data collection tool may also be used in embodiments of the present invention as long as it can measure culture of an organization.

Now referring to back FIG. 4, when customizing (step 407) the above, described guidelines, the following factors can also be considered by the facilitator.

1. What terms need to be modified in the interview guide?

2. What “management” and “senior management” terms does the client want to include in their organization?

3. Where should additional customized questions, if applicable, be added to the interview guide and the employee feedback sheet?

4. Ensure that if supervisory management focus groups are conducted that their quantitative measurement tool is the same as the one used in the interview guide.

Continuing to describe FIG. 4, the facilitator may also add client specific questions to generic guidelines (step 409). It should be noted that in this step as well as any step in the process of the present invention, the client may request that client's specific questions be added to the generic guidelines or request some questions on the generic guidelines be removed.

Exemplary specific questions may include the following questions:

1. “The company will see benefits from the merger/realignment of John Doe Company and Division A of the company?”

2. “I see personal benefits coming from the merger/realignment of John Doe Company and Division A of the company?”

3. “I'm concerned, either for enterprise or personally, about the overall merger/realignment?”

4. ”Communications in our new Division A are improving . . . timeliness, methods, and level of detail?”

5. “I believe Division A's Senior management is serious about improving employee satisfaction?”

6. “I believe Division A's Senior management will take actions to address issues identified in this survey/assessment?”

Each of the above question can be rated on a scale of, for example, 1-5 (1=Strongly Agree and 5=Strongly Disagree). Blanks spaces may also be provide to allow the participants to write comments.

In the maintain integrity step (step 413), the facilitator preferably ensures that responses to be collected from the members can be separated into the organizational groups and other relevant groupings of the members.

Following the customization of the generic guidelines, data (e.g., responses from the members) is gathered. There are a number of mechanisms to gather the data. More specifically, the above described generic and/or customized guidelines are used in gathering the data (e.g., the responses to the questions).

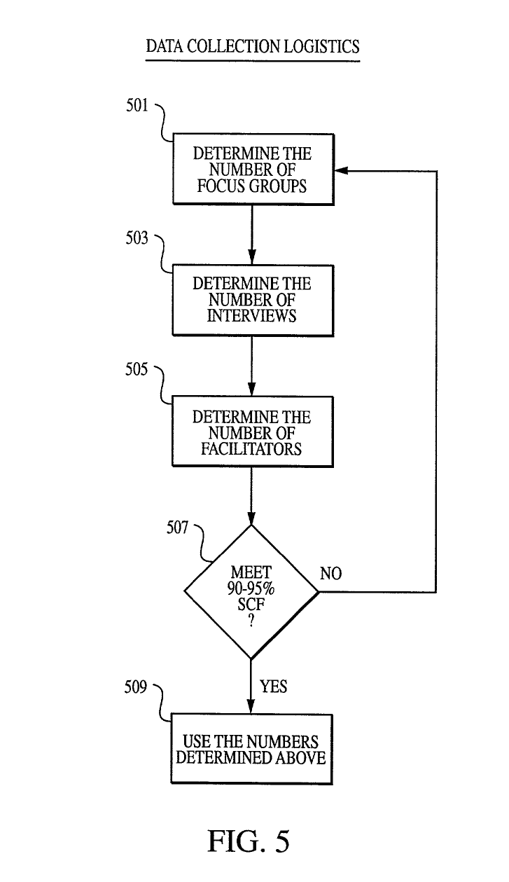

FIG. 6 graphically illustrates the different mechanisms, alternatively and/or in combination, with which to gather the data. As box 601 shows, the data can be gathered by holding a number of focus groups 613, each focus group being participated in by a number of members 615. Box 603 represents holding individual interviews with a number of different participating members of the organization.

Advantageously, another way to gather the data is conducting “visual walk around” assessments (box 605). While conducting the walking around assessments, the facilitator may determine whether or not there are any comments/concerns that can be substantiated and/or verified through a simple visual assessment. For instance, the verifiable comments/concerns may relate to cultural symbols, communication methods and timeliness, safety equipment, physical work conditions, management floor presence, consistency of practices/procedures, etc.

Yet another mechanism of gathering data is making available a computer terminal with which allows the members or other employees of the organization to enter the data voluntarily by identifying with their names or anonymously (box 607).

The above-described data gathering mechanisms can be performed as common exercises or as unique exercises. The common exercises are sessions during which any member can participate therein. The unique exercises are sessions during which members of a specific group may only be allowed to participate therein. An example of the unique focus group may be a senior management focus group meeting in which only senior managers are allowed to attend.

Once the data is gathered (e.g., responses to questions in the generic/customized guidelines, answers/observations recorded by the facilitators, etc.), the gathered data can be input into an electronic database (step 611). An exemplary database can be word processing software packages, e.g., Word, software spreadsheets, e.g., Excel, and/or a database management system, e.g., such as several standard databases provided by Oracle. Preferably, the integrity of the gathered data is maintained, or securely stored especially, with respect to the organizational groups. Various standard methods may be used to safely store the data.

The following are some of the preferred and optional additional steps performed by the facilitator while compiling (step 609) the gathered data. The first is to compile each question in focus group exercises and record all qualitative answers. These answers are preferably not edited. The second is to compile each question in the interview guide and record all qualitative and all qualitative responses. These responses are also preferably not edited. The third is to create one or more spreadsheets for the responses to the employee feedback sheets from the participated members. The fourth is to create one or more spreadsheets for the responses to the interview guide “rated” questions. It should be noted that the compilation step (step 609) and storing step (step 611) can be performed in any sequence or in parallel.

The above-described data compilation and store steps can be performed manually or automatically using, for example, character recognition systems as known in the art.

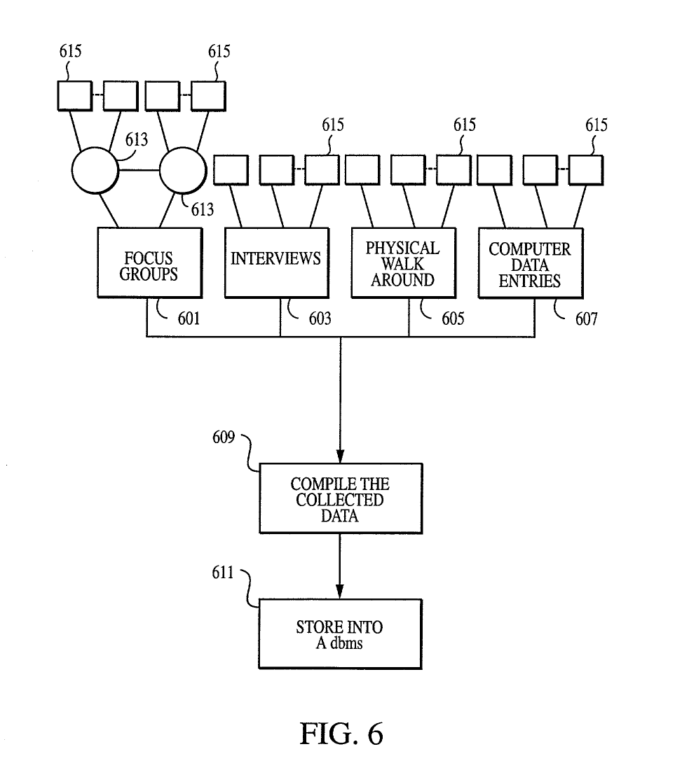

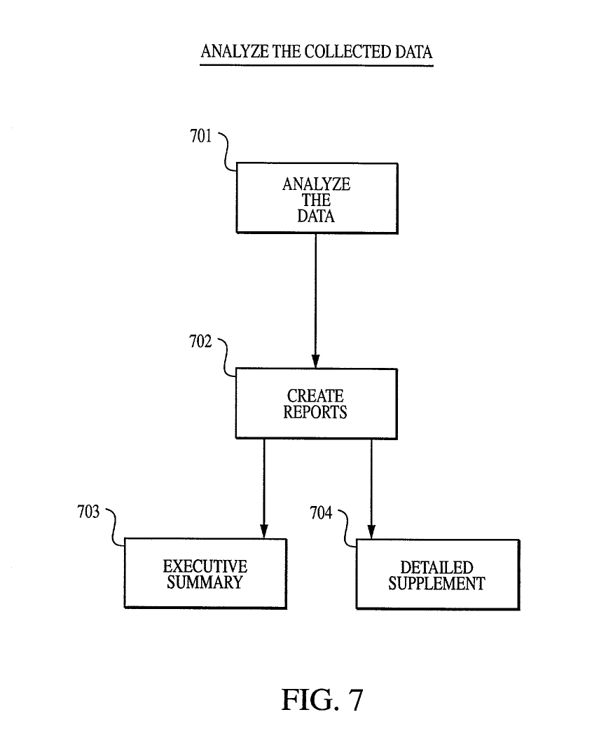

Now referring to FIG. 7, once the data has been gathered and compiled (e.g., collected), the data is then analyzed (step 701). A report is then created (step 702) based on the analyzed data. The reporting step may create an executive summary 703 and a detailed supplement report 704. These steps are described in detail in connection with FIG. 8 below.

As illustrated in FIG. 8, there are a number of data analysis steps. These steps can be performed manually or automatically using computerized text matching and data base searching algorithms known in the art.

The first step is to separate the collected data into a number of data sets, e.g., three sets (step 801). The first set may be the data gathered during the common exercises, e.g., focus groups and individual interviews. The second set may be the data collected during unique focus group activities/exercises. The third set is the data collected during unique interview activities/exercises. As a part of the separating step, data collected from the various organizational groups are optionally maintained as separate groups (step 803).

After the collected data has been separated, the next step is to conduct a trend analysis within each data set. The trend analysis is conducted by sorting and identifying one or more of the following themes/issues (step 805). Exemplary themes/issues may include: “What themes/issues are repeated throughout the data set?”; “What is the frequency of these themes/issues?”; “Are there details which further support these themes/issues in the data set?”; and “Are the themes/issues consistent across all the client specific organizational groups or are they unique to certain organizational groups?”

A list of themes/issues would have been identified as results of the trend analysis step. These identified themes/issues are preferably organized into a descending order of frequency, e.g., from the highest frequency theme/issue to the lowest (step 807). This step is to be repeated for each of the data sets. The facilitator may attempt to discern any “natural break” in the themes/issues frequency. “Natural break” is defined as, for example, any indicated in the themes/issues that can be grouped together in a band of common frequency.

Subsequent to or in parallel with the above step, the averages of responses to the quantitative questions are calculated. More specifically, there are ten (10) quantitative questions in the interview guide, and twenty-three (23) quantitative questions in the employee feedback sheet, as discussed above. The averages of the responses to the quantitative questions are then sorted in a descending order (step 809). This step is also performed on those customized questions which may require quantitative responses. The sorted average values may be referred as the quantitative data.

In the next step, the quantitative data is compared with the rated data collected in relation with the questions in the individual interview guideline (step 811). For instance, an employee group may rate the (6) Communications question on the employee feedback sheet low while a management group may also rate their Communications question high. In another example, an employee group rated “Showing Full Appreciation” low while the management group rated the same question high.

The next step is to compare quantitative results in order to qualitative results to determine whether the themes/issues compliment or contradict each other (step 813). An example of a contradiction is when the management team rated recognition as “above average” while the responses in the focus groups identified lack of appreciation as a frustration when answering qualitative questions. Another example pointing to a contradiction would be when employee groups rated “Personal Rapport” and “Accessibility” low on the employee feedback sheet while the management groups identified “Building Relationships” with employees as having no problem in the responses to the qualitative questions.

Subsequently, the results of the above described steps 807, 811, and 813, are analyzed in order to identify a certain number of themes/issues (e.g., 5, 4-6, 2-8, etc.) in each data set (step 815). Themes/issues that appear consistently across all data sets are also identified. In addition, the facilitator determines whether or not these identified themes/issues have been mentioned in qualitative data in, for example, a high frequency. Furthermore, the themes/issued identified may also be compared against data collected in other types of data collection mechanisms, e.g., words & their meaning exercise, trust exercise, Gap analysis or the like.

The results of the above-step are compared with the responses to the question of “What one realistic and specific thing would you do to improve morale and employee satisfaction in the next 90-120 days?” posed in the focus group meetings (step 817).

As the last step in the data analysis step, the results obtained above are summarized (step 819) in an executive summary report, with a detailed supplement report attached thereto.

The executive summary may include information relating to one or more the following items. The first item identifies and discusses common themes/issues. The common themes/issues may include one or more of the following items to be discussed in a narrative format: a summary of basic assumptions management has on its staff and employees have of business; a summary of responses to “What's going right/improving?”; a summary of responses to “What's frustrating/disappointing?”; a summary of responses to “What one realistic/specific thing would you do in the next 90-120 days to improve employee morale and satisfaction?” The common themes may also include one or more of the following items to be discussed in a qualitative format: a summary of responses to “Is the organization a better, same, or worse place to work over the last 6 months?”; and a summary of responses to “Is senior management serious about improving employee satisfaction?”

The second item in the executive summary identifies and discusses the results of the unique focus group meetings. The results of the unique focus group activities may include, for example, one or more of the following items to be discussed in a narrative format: a summary of responses in words and their meaning exercises; a summary of responses collected in the trust exercises; and a summary of the employee feedback sheet. The results of the unique focus group activities may include, for example, the following items to be discussed in a quantitative format; and a summary of responses to employee feedback select questions.

The third item in the executive summary identifies and discusses the results of the unique individual interview activities. The results of the unique interview activities may include, for example, one or more of the following items to be discussed: a summary of responses to the rated questions (highest and lowest scoring averages); and a summary of responses to the rated questions with significant average score differences between in the response of the management team and the employee groups.

The fourth item in the executive summary identifies and discusses the results of the key action areas. In this item, one or more of the following issues may be discussed: employee suggestions by action area from “one thing” exercise; and additional consultant recommendations based on best practices.

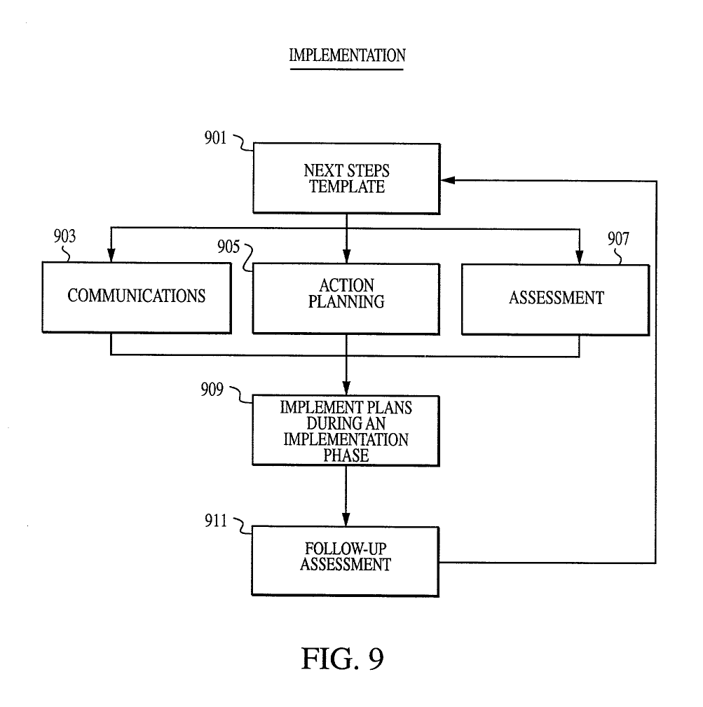

The last item in the executive summary includes the recommended next steps. The next steps include, for example, two categories, namely, soak time questions and a next steps template. The next steps template will be described later in connection with FIG. 10. However, the following is a list of exemplary soak time questions. The facilitator may ask the members to consider answering the following exemplary questions individually and then as a member of a management team.

1. “What was your first reaction to the cultural assessment survey results?”

2. “Were there any surprises? If so, why was they a surprise?”

3. ““What perceptions/beliefs were reinforced by this cultural assessment?”

4. “How will you address the employees' expectations generated from this process?”

5. “How will you continue to do the things you are doing well?”

6. “What time, tools, resources, dollars will you allocate to improve employee satisfaction this year?”

7. “Do your current goals/objectives address the areas for opportunity outlined in the cultural assessment?”

8. “What areas can your facility address without outside help? What areas need outside support?”

With respect to the detailed supplement report, this report provides details, for example, by the organizational groups. This may include one or more the following: a summary of responses from common interview and focus group questions; a summary of responses from words and their meanings exercises (focus groups); a summary of responses from trust exercises (focus group); a summary of responses from the GAP analyses (conducted during walk the talk or focus groups); a summary of responses from the employee feedback sheet (focus groups); and a summary of responses from management interview results (interviews). Other information may be included and/or substituted in the detailed supplement report.

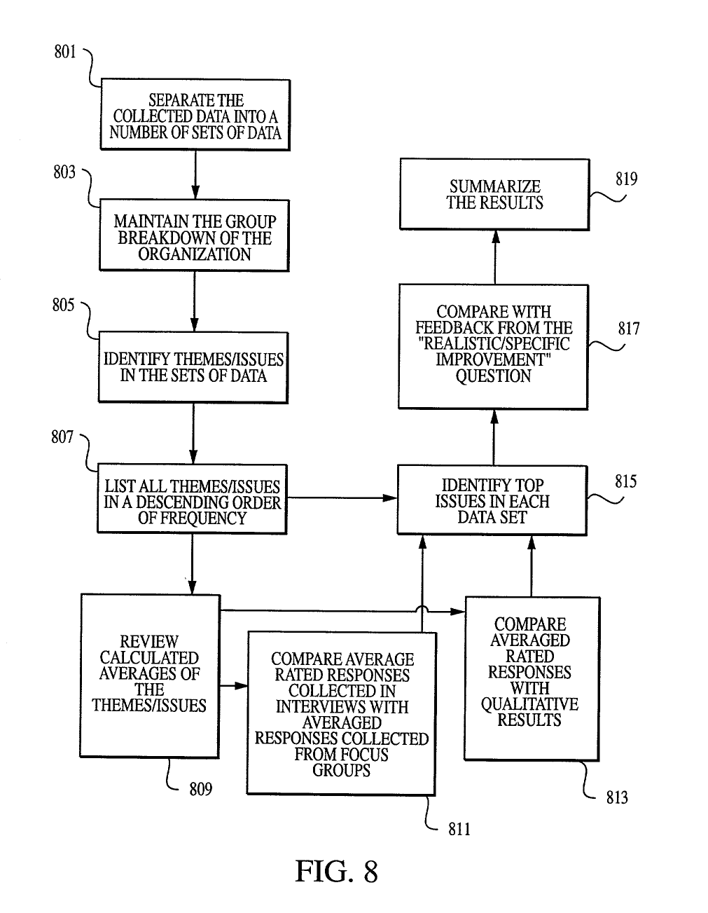

After the completion of the above-described step, the facilitator then performs the implementation step (step 305). Referring to FIG. 9, the implementation step includes the steps of communication (step 903), action planning (step 905), and assessment (step 907) based on the next steps template. The implementation is then carried out within a specified time period (step 909). A follow up assessment is conducted in some instances (step 911).

The implementation step is preferably performed so that it results in creating a detailed 100-120 day plan that may maximize or enhances the following: comments that have been mentally noted by the facilitator while conducting the processes of embodiments of the present invention; plan(s) that the facilitator intends address in key action areas; identify tangible actions/behaviors/activities; and assessments of employee perceptions.

Examples of the key action areas may include the following: Breakdown of key processes; Career Development/Opportunities; Communications; Company Image; Consistency; Empowerment; Equipment; Feedback; Gain sharing; Health & Safety; ISO Value; Lack of Rights; Leadership; Maintenance; Maximizing Customer Value; Pay/Benefits; PMI Fundamentals; Policies & Procedures; Positive Direction; Recognition; Roles & Responsibilities; Teamwork/Team building; Tools/Supplies; Training; Career Tracks; Values; We v. They; and Working Conditions.

FIG. 10 illustrates an exemplary next steps template that includes various steps to be performed during the implementation phase. An initial employee communication meeting 1001 may take place soon after the completion of data collection. A formed reaction and opinion gathering step 1003 can be on-going throughout the implementation phase (e.g., about 4 months). After 2-3 weeks, a senior management planning session 1005 can be held. After the senior management planning session, an all-employee meeting 1007 may be held. Subsequent to the all-employee meeting 1007, a detailed action plan meeting 1009 may be devised. A second meeting 1011 can be held. A goals and objectives assessment step 1013 can be on-going. At the end of the implementation phase an assessment 1015 can be made. The above sequence may be ordered differently and/or various steps modified, added and/or substituted. The following provides a more detailed exemplary description of the meetings and steps described above. Various alternatives or different combinations may also be utilized, and different sequences or orders of UTRS may be utilized. Further, one or more steps may be preferred in parallel with one another.

### 1. Initial Employee Communication 1001

In this meeting, the facilitator may distribute a letter to the members of the organization. The letter's objectives are, for example; to: a) thank everyone who participated in the processes; b) confirm that senior management received the formal report; c) share the key action areas identified; and d) communicate the time frame for additional information and next steps. The facilitator may ask all senior management to sign this letter. This step advantageously reinforces teamwork and overall commitment.

### 2. Informal Reaction/Opinions 1003

In this step, the facilitator takes every opportunity to make one-on-one conversations; staff meetings; and other employee forums to ask the members for their opinions regarding the progress/improvements being made in the implementation phase.

### 3. Senior Management Planning Session 1005

During this meeting the facilitator may discuss the following: a) review soak time questions; b) determine who and what will be communicated at all employee meeting; and c) begin developing a detailed action plan.

### 4. All Employee Meeting 1007

In this meeting the facilitator may discuss the following: a) key statistics; b) common questions & quotes; c) focus group survey results; and d) and the process the facility will use to address the cultural assessment findings.

### 5. Informal Reaction/Opinions

In this step the facilitator may take every opportunity one-on-one conversations, staff meetings, and other employee forums to ask the members for their opinions.

### 6. Detailed Action Plan Completed 1009

In this meeting the facilitator develops a detailed action plan to address opportunities identified in the cultural assessment. The plan may include information relating to the following items: a) specific actions that will be taken; b) time frames; c) who's responsible for completion; d) and resources needed.

### 7. Second All Employee Meeting 1011

The facilitator may hold a second all employee meeting focusing on the action plan.

### 8. Informal Reaction/Opinions

The facilitator takes every opportunity one-on-one conversations; staff meetings; and other employee forums to ask the members for their opinions.

### 9. Goals & Objectives 1013

The facilitator may incorporate incorporating elements of the cultural assessment action plan into individuals objectives.

### 10. Assessment 1015

In this step, the facilitator conducts a simple assessment to measure if the members perceive any changes that have occurred in the Key Action Areas.

Based on the above-described next steps template, the communications step (step 903) is preferably performed immediately after senior management receives the executive summary. The communication step may also include all employee meetings. These all hands meeting are to be held preferably at least two times: the first meeting may focus on “what we heard” and the focus of the second meeting is on “what we will do.” The communications step also include holding meetings directly with the supervisor team. It may also include holding monthly updates on status of the action plan.

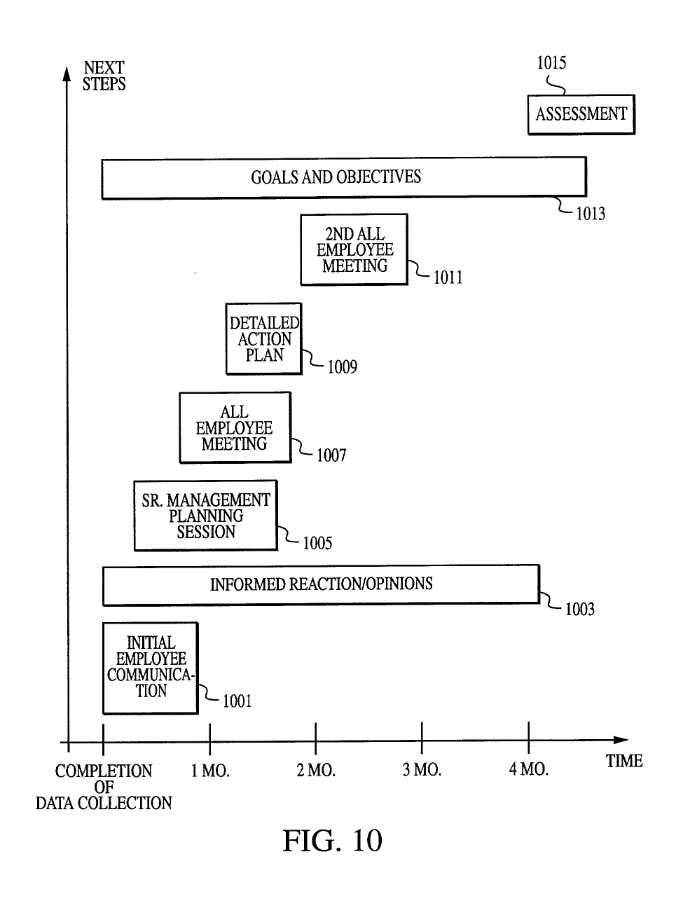

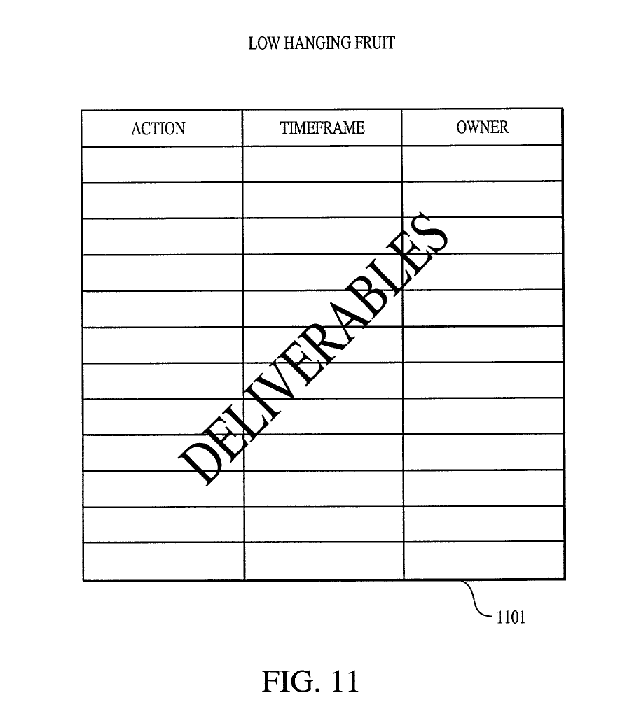

The action planning step (step 905) includes the step of reviewing employee and consultant recommendations for each key action area with a client action planning team, and generating an additional list of unique suggestions from the client action planning team. The action planning step may also include the step of picking off all “low hanging fruit” (LHF). The LHF are preferably no cost to low cost and easy to complete actions/activities within a short period (e.g., the first 30 days) after the collection of the data. Such LHF can be identified and filled into an exemplary LHF table shown in FIG. 11. Another step in the action planning step is to prioritize all remaining suggestions (employee/consultant/action planning team) using high, medium, or low rating. Furthermore, in this step, the facilitator may attempt to gain a consensus on all high rated suggestions making sure there is coverage in all identified key action areas. The facilitator then may complete a detailed implementation matrix for all consensus suggestions as shown in FIG. 12.

In the assessment step (step 907), a variety of formal and informal assessments can be conducted throughout the processes of embodiments of the present invention to measure employee perceptions and adjust activities. These may include, for example: reaction to cultural assessment (what we heard); reaction to the action plan (what we plan to do); and reaction to monthly action plan updates.

During the implementation phase, an action plan (e.g., a 100-day plan) may be implemented. During the implementation phase, the facilitator may monitor and track the client action plan and deliver on promised actions in the agreed upon manner and time frame.

In the follow up assessment step (steps 911), the facilitator may conduct short, formal assessment (written or online) regarding employee's perception of successful implementation of the client action plan. The facilitator may also provide a quantitative rating scale and solicit individual narrative feedback on all action plan items rated the same or worse since the process of embodiments of the present invention began. The results and significant trends identified thereby can be summarized by the facilitator. The implementation step described above in connection with FIG. 9 can be repeated.

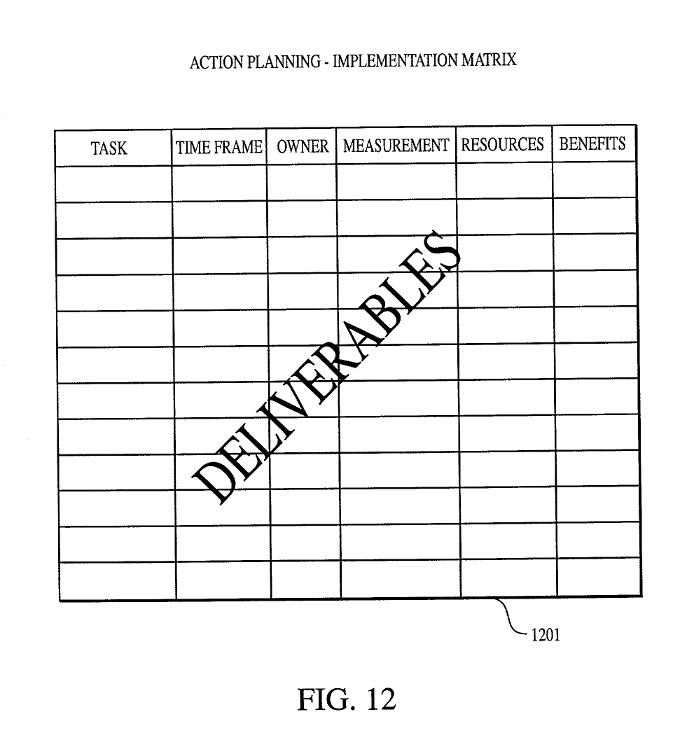

FIG. 13 is an illustration of the architecture of the combined Internet, POTS (plain, old, telephone service), and ADSL (asymmetric, digital, subscriber line) for use in accordance with the principles of the present invention. For instance, the data gathered in connection with FIG. 6 can be entered at a remote location using the Internet to a server. Furthermore, it is to be understood that the use of the Internet, ADSL, and POTS are for exemplary reasons only and that any suitable communications network may be substituted without departing from the principles of the present invention. This particular example is briefly discussed below.

In FIG. 13, to preserve POTS and to prevent a fault in the ADSL equipment 254, 256 from compromising analog voice traffic 226, 296 the voice part of the spectrum (the lowest 4 kHz) is separated from the rest by a passive filter, called a POTS splitter 258, 260. The rest of the available bandwidth—from about 10 kHz to 1 MHz—carries data at rates up to 6 bits per second for every hertz of bandwidth from data equipment 262, 264, and 294. The ADSL equipment 256 then has access to a number of destinations including significantly the Internet 220 or other data communications networks, and other destinations 270, 272.

To exploit the higher frequencies, ADSL makes use of advanced modulation techniques, of which the best known is the discrete multitone (DMT) technology. As its name implies, ADSL transmits data asymmetrically—at different rates upstream toward the central office 252 and downstream toward the subscriber 250.

Cable television providers are providing analogous Internet service to PC users over their TV cable systems by means of special cable modems. Such modems are capable of transmitting up to 30 Mb/s over hybrid fiber/coax system, which use fiber to bring signals to a location (e.g., a division of a corporation).

Cable modems come in many forms. Most create a downstream data stream out of one of the 6-MHz TV channels that occupy spectrum above 50 MHz (and more likely 550 MHz) and carve an upstream channel out of the 5-50-MHz band, which is currently unused. Using 64-state quadrature amplitude modulation (64 QAM), a downstream channel can realistically transmit about 30 Mb/s (the oft-quoted lower speed of 10 Mb/s refers to PC rates associated with Ethernet connections). Upstream rates differ considerably from vendor to vendor, but good hybrid fiber/coax systems can deliver upstream speeds of a few megabits per second. Thus, like ADSL, cable modems transmit much more information downstream than upstream. Then Internet architecture 220 and ADSL architecture 254, 256 may also be combined with, for example, user networks 222, 224, and 228.

In accordance with the principles of the present invention, in one example, a main computing server implementing the process of the invention may be located on one or more computing nodes or terminals (e.g., on user networks 222, 224, and 228 or system 240). Then, various users may interface with the main server via, for instance, the ADSL equipment discussed above, and access the information and processes of the present invention from remotely located PCs. As illustrated in this embodiment, users may access or use or interact with the computer assisted program in computer system 40 via various access methods. Databases 85, 86, 87, and 88 are accessible via, for example computer system 40 and may be used in conjunction with client manager module 91, tracking module 92, card readers 93, for the various functions described above. In another example, database 85 may contain collected data, and database 86 may contain compiled data.

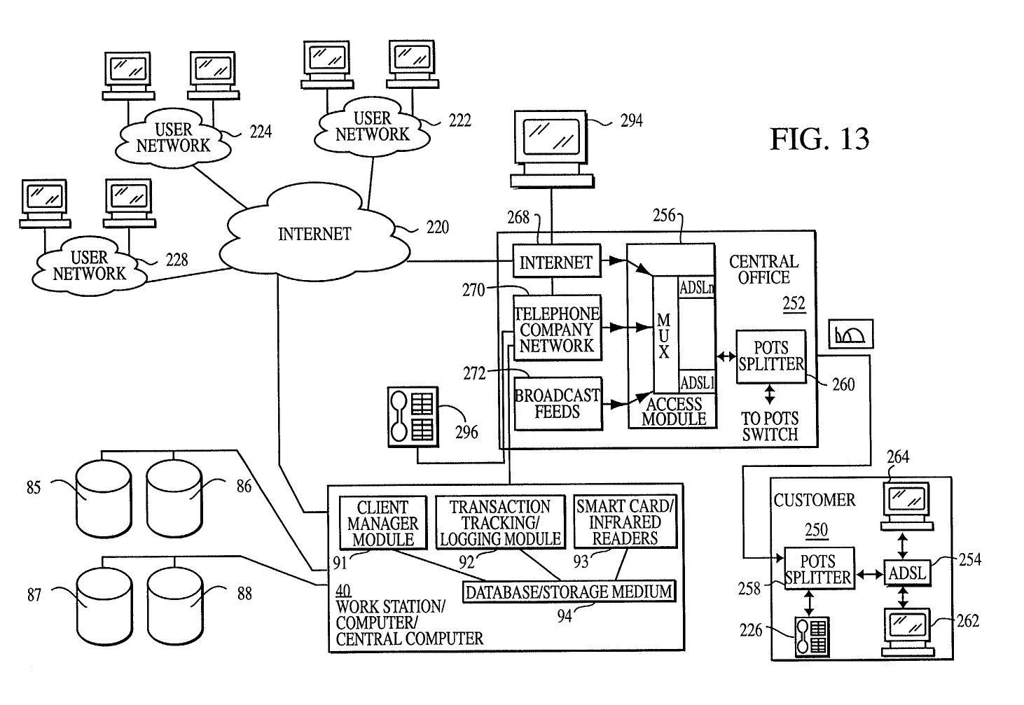

Viewed externally in FIG. 14, a computer system designated by reference numeral 1440 has a computer 1442 having disk drives 1444 and 1446. Disk drive indications 1444 and 1446 are merely symbolic of a number of disk drives which might be accommodated by the computer system. Typically, these would include a floppy disk drive 1444, a hard disk drive (not shown externally) and a CD ROM indicated by slot 1446. The number and type of drives vary, typically with different computer configurations. Disk drives 1444 and 1446 are in fact optional, and for space considerations, are easily omitted from the computer system used in conjunction with the production process/apparatus described herein.

The computer system also has an optional display upon which information screens may be displayed. In some situations, a keyboard 1450 and a mouse 1452 are provided as input devices through which a user's actions may be inputted, thus allowing input to interface with the central processing unit 1442. Then again, for enhanced portability, the keyboard 1450 is either a limited function keyboard or omitted in its entirety. In addition, mouse 1452 optionally is a touch pad control device, or a track ball device, or even omitted in its entirety as well, and similarly may be used to input a user's selections. In addition, the computer system also optionally includes at least one infrared transmitter and/or infrared received for either transmitting and/or receiving infrared signals, as described below.

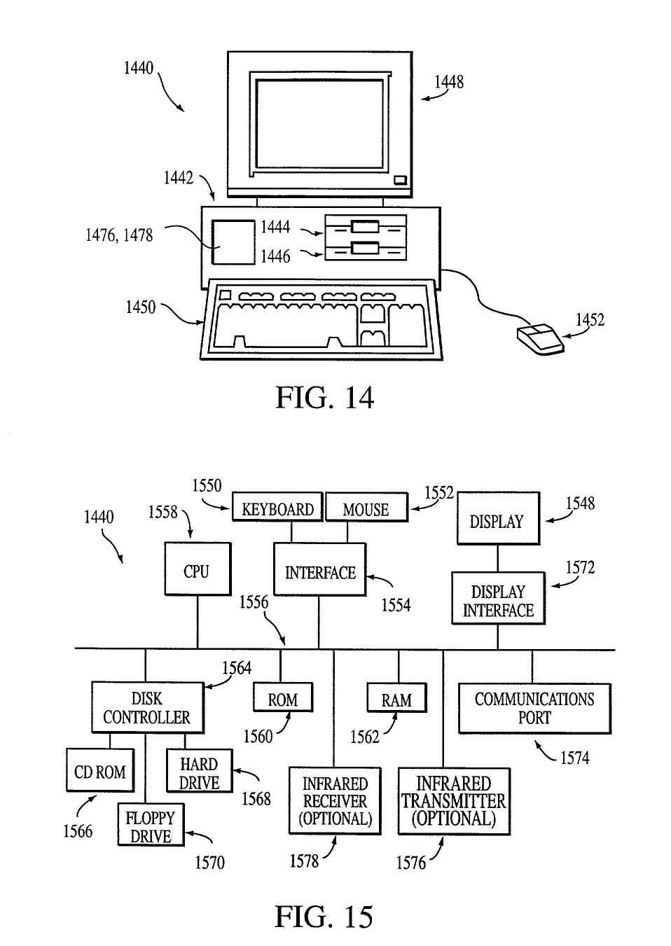

FIG. 15 illustrates a block diagram of one example of the internal hardware of a computer system 1440 that can include some of the processes of embodiments of the present invention. A bus 1556 serves as the main information highway interconnecting the other components of system 1440. CPU 1558 is the central processing unit of the system, performing calculations and logic operations required to execute the processes of embodiments of the present invention as well as other programs. Read only memory (ROM) 1560 and random access memory (RAM) 1562 constitute the main memory of the system. Disk controller 1564 interfaces one or more disk drives to the system bus 1556. These disk drives are, for example, floppy disk drives 1570, or CD ROM or DVD (digital video disks) drives 1566, or internal or external hard drives 1568. These various disk drives and disk controllers are optional devices.

A display interface 1572 interfaces display 1548 and permits information from the bus 1556 to be displayed on display 1548. Display 1548 is used in displaying a graphical user interface. Communications with external devices such as the other components of the system described above can occur utilizing, for example, communication port 1574. Optical fibers and/or electrical cables and/or conductors and/or optical communication (e.g., infrared, and the like) and/or wireless communication (e.g., radio frequency (RF), and the like) can be used as the transport medium between the external devices and communication port 1574. Peripheral interface 1556 interfaces the keyboard 1550 and mouse 1552, permitting input data to be transmitted to bus 1556. In addition to these components, system 1511 also optionally includes an infrared transmitter and/or infrared receiver. Infrared transmitters are optionally utilized when the computer system is used in conjunction with one or more of the processing components/stations that transmits/receives data via infrared signal transmission. Instead of utilizing an infrared transmitter or infrared receiver, the computer system may also optionally use a low power radio transmitter 1580 and/or a low power radio receiver 1582. The low power radio transmitter transmits the signal for reception by components of the production process, and receives signals from the components via the low power radio receiver. The low power radio transmitter and/or receiver are standard devices in industry.

Although system 1440 in FIG. 15 is illustrated having a single processor, a single hard disk drive and a single local memory, system 1440 is optionally suitably equipped with any multitude or combination of processors or storage devices. For example, system 1440 may be replaced by, or combined with, any suitable processing system operative in accordance with the principles of embodiments of the present invention, including sophisticated calculators, and hand-held, laptop/notebook, mini, mainframe and super computers, as well as processing system network combinations of the same.

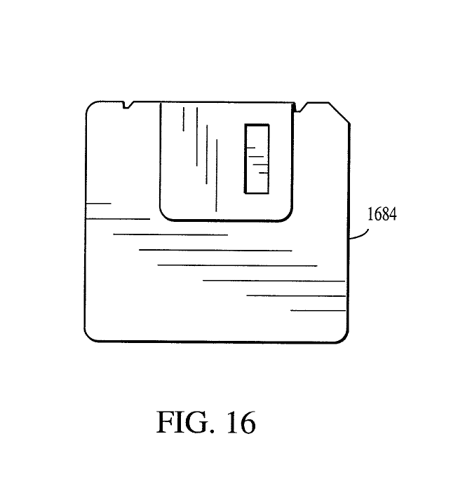

FIG. 16 is an illustration of an exemplary computer readable memory medium 1684 utilizable for storing computer readable code or instructions. As one example, medium 1684 may be used with disk drives illustrated in FIG. 15. Typically, memory media such as floppy disks, or a CD ROM, or a digital video disk will contain, for example, a multi-byte locale for a single byte language and the program information for controlling the above system to enable the computer to perform the functions described herein.

Alternatively, ROM 1560 and/or RAM 1562 illustrated in FIG. 15 can also be used to store the program information that is used to instruct the central processing unit 1558 to perform the operations associated with the instant processes. Other examples of suitable computer readable media for storing information include magnetic, electronic, or optical (including holographic) storage, some combination thereof, etc. In addition, at least some embodiments of the present invention contemplate that the medium can be in the form of a transmission (e.g., digital or propagated signals).

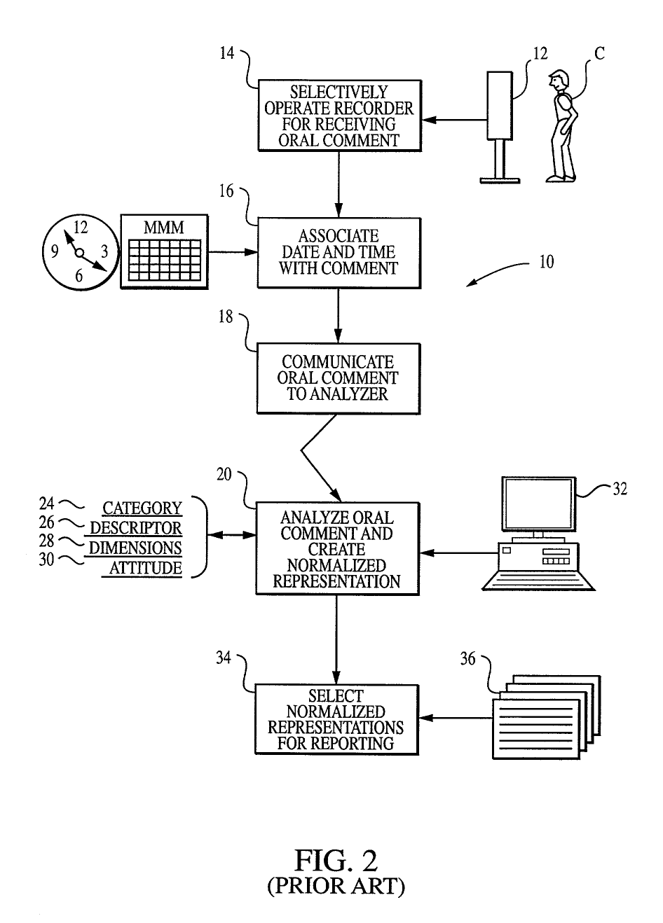

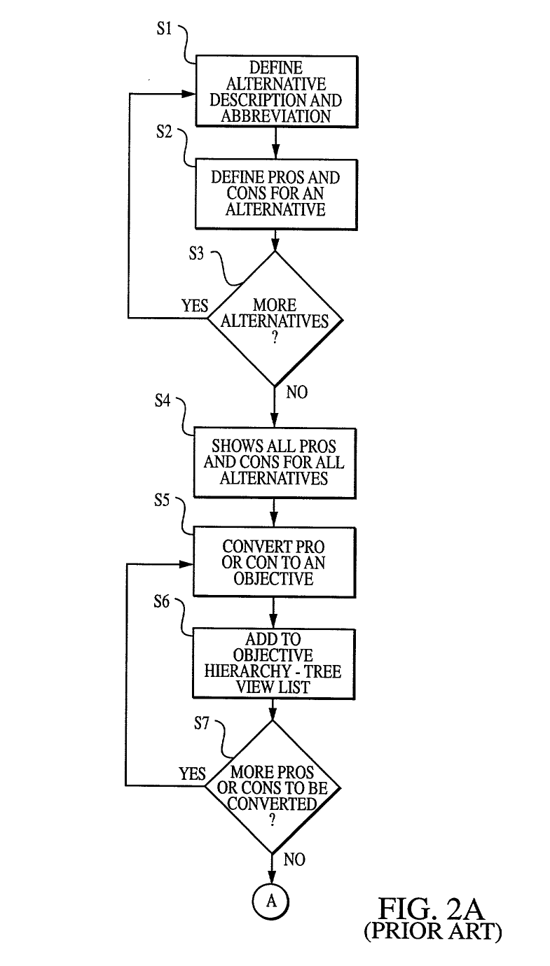

In addition to the above-described computer implementation of embodiments of the present invention, the decisions to be made by the facilitator (e.g., determining the recurring themes/issues, determining what actions to take, etc.) can be assisted by a decision assisting tool. One example of such a decision assisting tool can be developed and implemented with some of the concepts described in connection with FIGS. 2A and 2B.

The many features and advantages of the invention are apparent from the detailed specification, and thus, it is intended by the appended claims to cover all such features and advantages of the invention which fall within the true spirit and scope of the invention.

Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

### INDUSTRIAL APPLICABILITY

With the above-described computer, communicator, data storage and/or data analysis systems, employers can quickly assess employee satisfaction and response thereto.

What is claimed is:

1. A computer implemented or computer assisted method of measuring and assessing culture of an organization and making improvements thereon, comprising the steps of:
collecting by at least one of computer and a user responses from members of the organization;
compiling the responses into an analyzable data format generating compiled data;
determining at least one of themes and issues by analyzing the compiled data;
determining at least one action corresponding to the at least one of themes and issues determined by said determining themes and issues step;
implementing the at least one action on the organization determined by said determining at least one action step;
assessing an effect of said implementing step on the organization; and
determining at least one additional action responsive to the effect determined by said assessing step.

2. The method of claim 1, wherein the step of collecting responses further includes the steps of:
performing at least one individual interview session with at least one of the members;
performing at least one focus group meeting with at least one of the members; and
performing at least one physical walk around with at least one of the members.

3. The method of claim 1, wherein the step of compiling the responses includes the steps of:
separating the collected responses into groups.

4. The method of claim 1, wherein the step of determining themes or issues includes the step of:
determining ineffectual communication between employees and managers of the organization as a theme.

5. The method of claim 1, wherein the step of determining said action includes the step of:
increasing communication between employees and managers by posting relevant messages on a board or a Web page of the organization.

6. A computer implemented or assisted method of analyzing data collected as part of a cultural assessment process, wherein the data includes responses to qualitative questions and quantitative questions collected in at least one of a user interview computer program, individual interviews, focus group meetings, questionnaires, and culture assessment tools, comprising the steps of:
calculating averages of the responses to the quantitative questions collected from the at least one individual interview;
calculating averages of the responses to the quantitative questions collected from the at least one focus group meeting; and
determining at least one of themes and issues by comparing the calculated averages of the responses to the quantitative questions collected from the at least one individual interview and the calculated averages of the responses to the quantitative questions collected from the at least one focus group meeting.

7. The method of claim 6, further including the steps of:
separating the collected data into a number of sets; and
determining at least one of themes and issues appearing repeatedly in the collected data for each set of data.

8. The method of claim 7, further comprising the step of:
determining at least one of themes and issues by comparing the calculated averages and the responses to the qualitative questions.

9. A computer implemented or assisted system for measuring and assessing culture of an organization and making improvements thereon, comprising:
means for collecting by at least one of computer and a user responses from members of the organization;
means for compiling the responses into an analyzable data format generating compiled data;
means for determining at least one of themes and issues by analyzing the compiled data;
means for determining at least one action corresponding to the at least one of themes and issues determined by said means for determining themes and issues;
means for causing the at least one action determined by said means for determining at least one action to be implemented on the organization; and
means for assessing an effect made by said implementation of at least one action on the organization.

10. The system of claim 9, wherein the means for collecting responses further includes:
means for compiling data collected from at least one individual interview session with at least one of the members;
means for compiling data collected from at least one focus group meeting with at least one of the members; and
means for compiling data collected from at least one walk around interview with at least one of the members.

11. The system of claim 9, wherein the means for compiling the responses includes:
means for separating the collected responses into groups.

12. The system of claim 9, wherein the means for determining themes or issues further includes:
means for determining ineffectual communication between employees and managers of the organization as a theme.

13. A computer implemented or assisted system for analyzing data collected as part of a cultural assessment process, wherein the data includes responses to qualitative questions and quantitative questions collected in at least one of a user interview computer program, individual interviews, focus group meetings, questionnaires, and culture assessment tools, comprising:
means for calculating averages of the responses to the quantitative questions collected from the at least one individual interview;
means for calculating averages of the responses to the quantitative questions collected from the at least one focus group meeting; and
means for determining at least one of themes and issues by comparing the calculated averages of the responses to the quantitative questions collected from the at least one individual interview and the calculated averages of the responses to the quantitative questions collected from the at least one focus group meeting.

14. The system of claim 13, further including:
means for separating the collected data into a number of sets; and
means for determining at least one of themes and issues appearing repeatedly in the collected data for each set of data.

15. The system of claim 13, further including:
means for determining at least one of themes and issues by comparing the calculated averages and the responses to the qualitative questions.

16. A computer readable medium including instructions being executed by a computer, the instructions instructing the computer to measure and/or assess culture of an organization and make improvements thereon, instructions comprising:
collecting by at least one of computer and a user responses from members of the organization;
compiling the responses into an analyzable data format generating compiled data;
determining at least one of themes and issues by analyzing the compiled data;
determining at least one action corresponding to the at least one of themes and issues determined by said instructions for determining themes and issues;
causing the at least one action determined by said instructions for determining at least one action to be implemented on the organization; and
assessing an effect made by said implementation of at least one action on the organization.

17. The medium of claim 16, wherein the instructions for collecting responses further includes the instructions for:
compiling data collected from at least one individual interview session with at least one of the members;
compiling data collected from at least one focus group meeting with at least one of the members; and
compiling data collected from at least one walk around interview with at least one of the members.

18. The medium of claim 16, wherein the instructions for compiling the responses includes the instructions for:
separating the collected responses into groups.

19. The medium of claim 16, wherein the instruction for determining themes or issues further includes the instructions for:
determining ineffectual communication between employees and managers of the organization as a theme.

20. A computer readable medium including instructions being executed by a computer, the instructions instructing the computer to analyze data collected as part of a cultural assessment process, wherein the data includes responses to qualitative questions and quantitative questions collected in at least one of a user interview computer program, individual interviews, focus group meetings, questionnaires, and culture assessment tools, the instructions comprising:
calculating averages of the responses to the quantitative questions collected from the at least one individual interview;
calculating averages of the responses to the quantitative questions collected from the at least one focus group meeting; and
determining at least one of themes and issues by comparing the calculated averages of the responses to the quantitative questions collected from the at least one individual interview and the calculated averages of the responses to the quantitative questions collected from the at least one focus group meeting.

21. The medium of claim 20, further including the instructions for:
separating the collected data into a number of sets; and
determining at least one of themes and issues appearing repeatedly in the collected data for each set of data.

22. The medium of claim 20, further including the instructions for:
determining at least one of themes and issues by comparing the calculated averages and the responses to the qualitative questions.

23. An expert system comprising:
a processor;
a computer readable medium including instructions executable by said processor, the instructions instructing the computer to measure and/or assess culture of an organization and make improvements thereon, the instructions comprising:
collecting by at least one of computer and a user responses from members of the organization;
compiling the responses into an analyzable data format generating compiled data;
determining at least one of themes and issues by analyzing the compiled data;
determining at least one action corresponding to the at least one of themes and issues determined by said instructions for determining themes and issues;
causing the at least one action determined by said instructions for determining at least one action to be implemented on the organization; and
assessing an effect made by said implementation of at least one action on the organization.

24. The expert system of claim 23, wherein the instructions for collecting responses further includes the instructions for:
compiling data collected from at least one individual interview session with at least one of the members;
compiling data collected from at least one focus group meeting with at least one of the members; and
compiling data collected from at least one walk around interview with at least one of the members.

25. The expert system of claim 23, wherein the instructions for compiling the responses includes the instructions for:
separating the collected responses into groups.

26. The expert system of claim 23, wherein the instruction for determining themes or issues further includes the instructions for:
determining ineffectual communication between employees and managers of the organization as a theme.

27. An expert system comprising:
a processor;
a computer readable medium including instructions executable by said processor, the instructions instructing the computer to analyze data collected as part of a cultural assessment process, wherein the data includes responses to qualitative questions and quantitative questions collected in at least one of a user interview computer program, individual interviews, focus group meetings, questionnaires, and culture assessment tools, the instructions comprising:
calculating averages of the responses to the quantitative questions collected from the at least one individual interview;
calculating averages of the responses to the quantitative questions collected from the at least one focus group meeting; and
determining at least one of themes and issues by comparing the calculated averages of the responses to the quantitative questions collected from the at least one individual interview and the calculated averages of the responses to the quantitative questions collected from the at least one focus group meeting.

28. The expert system of claim 27, further including the instructions for:
separating the collected data into a number of sets; and
determining at least one of themes and issues appearing repeatedly in the collected data for each set of data.

29. The expert system of claim 27, further including the instructions for:
determining at least one of themes and issues by comparing the calculated averages and the responses to the qualitative questions.

30. In a computer system to measure and/or assess culture of an organization and make improvements thereon, a computer data signal embodied in a carrier wave, said signal bearing instructions to be executed by the computer system, said instructions comprising:
collecting by at least one of computer and a user responses from members of the organization;
compiling the responses into an analyzable data format generating compiled data;
determining at least one of themes and issues by analyzing the compiled data;
determining at least one action corresponding to the at least one of themes and issues determined by said instructions for determining themes and issues;
causing the at least one action determined by said instructions for determining at least one action to be implemented on the organization; and
assessing an effect made by said implementation of at least one action on the organization.

31. The signal of claim 30, wherein the instructions for collecting responses further includes the instructions for:
compiling data collected from at least one individual interview session with at least one of the members;
compiling data collected from at least one focus group meeting with at least one of the members; and
compiling data collected from at least one walk around interview with at least one of the members.

32. The signal of claim 30, wherein the instructions for compiling the responses includes the instructions for:
separating the collected responses into groups.

33. The signal of claim 30, wherein the instruction for determining themes or issues further includes the instructions for:
determining ineffectual communication between employees and managers of the organization as a theme.

34. In a computer system to analyze data collected as part of a cultural assessment process, wherein the data includes responses to qualitative questions and quantitative questions collected in at least one of a user interview computer program, individual interviews, focus group meetings, questionnaires, and culture assessment tools, a computer data signal embodied in a carrier wave, said signal bearing instructions to be executed by the computer system, the instructions comprising:
calculating averages of the responses to the quantitative questions collected from the at least one individual interview;
calculating averages of the responses to the quantitative questions collected from the at least one focus group meeting; and
determining at least one of themes and issues by comparing the calculated averages of the responses to the quantitative questions collected from the at least one individual interview and the calculated averages of the responses to the quantitative questions collected from the at least one focus group meeting.

35. The signal of claim 34, further including the instructions for:
separating the collected data into a number of sets; and
determining at least one of themes and issues appearing repeatedly in the collected data for each set of data.

36. The signal of claim 34, further including the instructions for:
determining at least one of themes and issues by comparing the calculated averages and the responses to the qualitative questions.

37. A computer implemented or computer assisted method of measuring and assessing culture of an organization and making improvements thereon, comprising the steps of:
collecting by at least one of computer and a user responses from members of the organization, including the steps of:
performing at least one individual interview session with at least one of the members;
performing at least one focus group meeting with at least one of the members; and
performing at least one walk around interview with at least one of the members;
compiling the responses into an analyzable data format generating compiled data;
determining at least one of themes and issues by analyzing the compiled data, including the steps of:
determining ineffectual communication between employees and managers of the organization as a theme;
determining at least one action corresponding to the at least one of themes and issues determined by said determining themes and issues step;
implementing the at least one action on the organization determined by said determining at least one action step, including the step of:
increasing communication between employees and managers by posting relevant messages on a board or a Web page of the organization;
assessing an effect of said implementing step on the organization; and
determining at least one additional action responsive to the effect determined by said assessing step.

38. A computer implemented or assisted method of analyzing data collected as part of a cultural assessment process, wherein the data includes responses to qualitative questions and quantitative questions collected in at least one of a user interview computer program, individual interviews, focus group meetings, questionnaires, and culture assessment tools, comprising the steps of:
calculating averages of the responses to the quantitative questions collected from the at least one individual interview;
calculating averages of the responses to the quantitative questions collected from the at least one focus group meeting;
determining at least one of themes and issues by comparing the calculated averages of the responses to the quantitative questions collected from the at least one individual interview and the calculated averages of the responses to the quantitative questions collected from the at least one focus group meeting;
separating the collected data into a number of sets;
determining at least one of themes and issues appearing repeatedly in the collected data for each set of data; and
determining at least one of themes and issues by comparing the calculated averages and the responses to the qualitative questions.

39. A computer implemented or assisted system for measuring and assessing culture of an organization and making improvements thereon, comprising:
means for collecting by at least one of computer and a user responses from members of the organization, including:
means for compiling data collected from at least one individual interview session with at least one of the members;
means for compiling data collected from at least one focus group meeting with at least one of the members; and
means for compiling data collected from at least one walk around interview with at least one of the members;
means for compiling the responses into an analyzable data format generating compiled data;
means for determining at least one of themes and issues by analyzing the compiled data, including:
means for determining ineffectual communication between employees and managers of the organization as a theme;
means for determining at least one action corresponding to the at least one of themes and issues determined by said means for determining themes and issues;
means for causing the at least one action determined by said means for determining at least one action to be implemented on the organization; and
means for assessing an effect made by said implementation of at least one action on the organization.

40. A computer implemented or assisted system for analyzing data collected as part of a cultural assessment process, wherein the data includes responses to qualitative questions and quantitative questions collected in at least one of a user interview computer program, individual interviews, focus group meetings, questionnaires, and culture assessment tools, comprising:
means for calculating averages of the responses to the quantitative questions collected from the at least one individual interview;
means for calculating averages of the responses to the quantitative questions collected from the at least one focus group meeting;
means for determining at least one of themes and issues by comparing the calculated averages of the responses to the quantitative questions collected from the at least one individual interview and the calculated averages of the responses to the quantitative questions collected from the at least one focus group meeting;
means for separating the collected data into a number of sets;
means for determining at least one of themes and issues appearing repeatedly in the collected data for each set of data; and
means for determining at least one of themes and issues by comparing the calculated averages and the responses to the qualitative questions.
